(19) United States
(12) Patent Application Publication
(10) Pub. No.: US 2024/0010098 A1
(43) Pub. Date: Jan. 11, 2024

(54) INFORMATION PROCESSING METHOD, INFORMATION PROCESSING SYSTEM, AND RECORDING MEDIUM

(71) Applicant: Panasonic Intellectual Property Corporation of America, Torrance, CA (US)

(72) Inventors: Kotaro SAKATA, Osaka (JP); Tetsuji FUCHIKAMI, Osaka (JP)

(21) Appl. No.: 18/371,178

(22) Filed: Sep. 21, 2023

Related U.S. Application Data
(63) Continuation of application No. PCT/JP2021/044404, filed on Dec. 3, 2021.

(30) Foreign Application Priority Data
Apr. 2, 2021 (JP) 2021-063666

(51) Int. Cl. B60L 53/66; G07C 5/04; B60L 58/12; G06Q 50/06; G06Q 30/04

(52) U.S. Cl. CPC B60L 53/665; G07C 5/04; B60L 58/12; G06Q 50/06; G06Q 30/04

(57) ABSTRACT

An information processing method includes: obtaining an amount of charge when a moving body propelled by electrical power is charged by a charging facility; obtaining history information on locations that the moving body has traveled to during travels and remaining battery levels during the travels; obtaining waypoint information that indicates a location that the moving body has passed through during a first type of travel among the travels; and identifying, by using the history information and the waypoint information, a first amount of power used during the first type of travel out of the amount of charge, or a second amount of power used during a second type of travel out of the amount of charge, and outputting the first amount of power or the second amount of power, the second type of travel being the travels excluding the first type of travel.

### CROSS REFERENCE TO RELATED APPLICATIONS

This is a continuation application of PCT International Application No. PCT/JP2021/044404 filed on Dec. 3, 2021, designating the United States of America, which is based on and claims priority of Japanese Patent Application No. 2021-063666 filed on Apr. 2, 2021. The entire disclosures of the above-identified applications, including the specifications, drawings and claims are incorporated herein by reference in their entirety.

### FIELD

The present disclosure relates to an information processing method, an information processing system, and a recording medium.

### BACKGROUND There is a charging system for easily calculating a fee in accordance with power transmitted to an electric automobile (see Patent Literature (PTL) 1).

### CITATION LIST

### Patent Literature

PTL 1: WO 2014/003106

### SUMMARY

### Technical Problem

However, when a moving body propelled by electrical power is used for traveling for a plurality of purposes of a user, fees cannot be appropriately calculated according to a plurality of travel purposes.

In view of this, the present disclosure provides an information processing method, and the like, that appropriately calculates fees according to a plurality of travel purposes of a moving body.

### Solution to Problem

An information processing method according to one aspect of the present disclosure includes: obtaining an amount of charge when a moving body propelled by electrical power is charged by a charging facility; obtaining history information on locations that the moving body has traveled to during travels and remaining battery levels during the travels; obtaining waypoint information that indicates a location that the moving body has passed through during a first type of travel among the travels; and identifying, by using the history information and the waypoint information, a first amount of power used during the first type of travel out of the amount of charge, or a second amount of power used during a second type of travel out of the amount of charge, and outputting the first amount of power or the second amount of power, the second type of travel being the travels excluding the first type of travel.

It should be noted that these generic and specific aspects may be implemented as a system, a device, an integrated circuit, a computer program, or a computer-readable recording medium such as a CD-ROM, or may be implemented as any combination of a system, a device, an integrated circuit, a computer program, and a recording medium.

### ADVANTAGEOUS EFFECTS

The information processing method according to the present disclosure can appropriately calculate fees according to a plurality of travel purposes of a moving body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a configuration and use of an information processing system according to Embodiment 1.

FIG. 2 is a block diagram illustrating a functional configuration of an information processing device according to Embodiment 1.

FIG. 3 is a schematic diagram illustrating an example of travel by a vehicle according to Embodiment 1.

FIG. 4 is a schematic diagram illustrating an example of remaining battery levels of the vehicle according to Embodiment 1.

FIG. 5 is a diagram for describing a first example of waypoint information according to Embodiment 1.

FIG. 6 is a diagram for describing a second example of waypoint information according to Embodiment 1.

FIG. 7 is a diagram for describing a breakdown by purpose of an amount of charge identified by an identifier according to Embodiment 1.

FIG. 8 is a flowchart illustrating an information processing method according to Embodiment 1.

### DESCRIPTION OF EMBODIMENT

### Underlying Knowledge Forming Basis of the Present Disclosure

In relation to the use of an electric automobile as described in the “Background”, the inventors have found the following problems.

It is assumed that a single electric automobile will be used for both travel for the purpose of performing work and travel for purposes other than performing such work. Such use of electric automobiles can help to encourage the widespread adoption of electric automobiles. This is because costs for adopting and operating electric automobiles can be reduced. Promoting the widespread adoption of electric automobiles produces the advantageous effect of reducing the amount of carbon dioxide emissions compared to when automobiles that use fossil fuels, such as gasoline, are used, thereby curbing global warming.

For example, a user possesses a single electric automobile that is used for both travel for the purpose of performing work and travel for purposes other than performing such work. In this case, the user may be permitted to charge the electric automobile using a charging facility installed at a business site of a company to which the user belongs. In this case, the need to possess a charging facility at home is eliminated, and costs for adopting and operating an electric automobile can be reduced.

In this case, it is generally considered reasonable for the company to bear the fee for the amount of power used for travel for the purpose of performing work, and for the user to bear the fee for the amount of power used for travel for purposes other than performing work.

Accordingly, in a billing process for the amount of power used for charging, being able to distinguish between the amount of power used for travel for the purpose of performing work and the amount of power used for travel for purposes other than performing work has the advantageous effect of being able to enhance efficiency of the information processing needed for managing the electric automobile. The “billing process” as described here is a process for the company to collect, from the user, payment that is equivalent to the amount of power used for charging.

However, in the conventional billing process, there is the problem that fees cannot be calculated according to a plurality of purposes of use of an electric automobile.

In view of this, the present disclosure provides an information processing method, and the like, that can appropriately calculate fees according to a plurality of purposes of use of an electric automobile.

An information processing method according to one aspect of the present disclosure includes: obtaining an amount of charge when a moving body propelled by electrical power is charged by a charging facility; obtaining history information on locations that the moving body has traveled to during travels and remaining battery levels during the travels; obtaining waypoint information that indicates a location that the moving body has passed through during a first type of travel among the travels; and identifying, by using the history information and the waypoint information, a first amount of power used during the first type of travel out of the amount of charge, or a second amount of power used during a second type of travel out of the amount of charge, and outputting the first amount of power or the second amount of power, the second type of travel being the travels excluding the first type of travel.

According to this aspect, since the information processing method identifies the first amount of power used during the first type of travel of the moving body or the second amount of power used during the second type of travel by using locations that the moving body has passed through during the first type of travel, a more appropriate first amount of power or second amount of power can thus be identified. Furthermore, since an appropriately identified first amount of power or second amount of power is used, it is possible to appropriately calculate fees according to a plurality of travel purposes of the moving body. Accordingly, the above-mentioned information processing method can appropriately calculate fees according to a plurality of travel purposes of the moving body.

For example, in the identifying of the first amount of power: a first route portion may be identified by using the waypoint information, the first route portion being a route traveled by the moving body during the first type of travel out of routes that the moving body has traveled during the travels; and an amount of power, out of the amount of charge, used by the moving body to travel the first route portion may be identified as the first amount of power.

According to this aspect, the information processing method can appropriately identify the routes traveled during the first type of travel of the moving body by using the waypoint information and, in addition, can appropriately identify the first amount of power. Accordingly, the above-mentioned information processing method can more appropriately calculate fees according to a plurality of travel purposes of the moving body.

For example, in the identifying of the second amount of power: a first route portion may be identified by using the waypoint information, the first route portion being a route traveled by the moving body during the first type of travel out of routes that the moving body has traveled during the travels; a second route portion may be identified, the second route portion being the routes excluding the first route portion; and an amount of power, out of the amount of charge, used by the moving body to travel the second route portion may be identified as the second amount of power.

According to this aspect, the information processing method can appropriately identify the routes traveled during the first type of travel of the moving body by using the waypoint information and, in addition, can appropriately identify the second amount of power. Accordingly, the above-mentioned information processing method can more appropriately calculate fees according to a plurality of travel purposes of the moving body.

For example, the information processing method may further include, when the second amount of power is identified, executing a billing process for the second amount of power.

According to this aspect, since the information processing method executes the billing process for the second amount of power by using the appropriately identified second amount of power, the billing process can be made to be more appropriate. Accordingly, the above-mentioned information processing method can more appropriately calculate fees according to a plurality of travel purposes of the moving body.

For example, in the executing of the billing process, billing for an amount obtained by multiplying the second amount of power by a predetermined proportion of a market unit price of electrical power may be executed.

According to this aspect, the information processing method can increase the motivation of the user to use the moving body by reducing the amount billed for the second amount of power by a predetermined proportion in the billing process. As a result, this can contribute to the promotion of the widespread adoption of moving bodies propelled by electrical power. Accordingly, the widespread adoption of moving bodies propelled by electrical power can be encouraged and fees can be appropriately calculated according to a plurality of travel purposes.

For example, in the executing of the billing process, billing for the first amount of power may be prohibited.

According to this aspect, the information processing method can increase the motivation of the user to use the moving body by not executing billing for the first amount of power. As a result, this can contribute to the promotion of the widespread adoption of moving bodies propelled by electrical power. Accordingly, the widespread adoption of moving bodies propelled by electrical power can be encouraged and fees can be appropriately calculated according to a plurality of travel purposes.

For example, the information processing method may further include calculating and outputting a difference between (a) an amount of carbon dioxide emissions generated in a case where a vehicle fueled by gasoline travels the first type of travel and (b) an amount of carbon dioxide emissions generated during the first type of travel of the moving body.

According to this aspect, since the information processing method outputs the amount of carbon dioxide emissions that would be reduced when compared to a hypothetical case where the first type of travel of the moving body were to be carried out by a vehicle fueled by gasoline, the user can be further motivated to use the moving body. As a result, this can contribute to the promotion of the widespread adoption of moving bodies propelled by electrical power. Accordingly, it is possible to appropriately calculate fees according to a plurality of travel purposes while contributing to the promotion of the widespread adoption of moving bodies propelled by electrical power.

For example, the charging facility may be predetermined to be a charging facility for charging the moving body with electrical power to be used for the first type of travel of the moving body.

According to this aspect, in the information processing method, electrical power to be used by the moving body for both the first type of travel and the second type of travel can be provided using a charging facility installed for the purpose of supplying electrical power to be used for the first type of travel. Furthermore, the charging facility can be appropriately used in supplying electrical power to the moving body that is used for both the first type of travel and the second type of travel. Accordingly, it is possible to more appropriately calculate fees according to a plurality of travel purposes of a moving body by using a charging facility for the first type of travel.

For example, the first type of travel may be for a purpose of performing work of a user, and the second type of travel may be for a purpose other than performing work of the user.

According to this aspect, the information processing method can appropriately calculate fees according to a plurality of travel purposes for a moving body used for both travel for the purpose of performing work of the user and travel for purposes other than performing work of the user.

Furthermore, an information processing system according to one aspect of the present disclosure includes: an obtainer that: (a) obtains an amount of charge when a moving body propelled by electrical power is charged by a charging facility; (b) obtains history information on locations that the moving body has traveled to during travels and remaining battery levels during the travels; and (c) obtains waypoint information that indicates a location that the moving body has passed through during a first type of travel among the travels; an identifier that identifies, by using the history information and the waypoint information, a first amount of power used during the first type of travel out of the amount of charge, or a second amount of power used during a second type of travel out of the amount of charge, the second type of travel being the travels excluding the first type of travel; and an output unit that outputs the first amount of power or the second amount of power identified by the identifier.

According to this aspect, the same advantageous effects as the above-mentioned information processing method are achieved.

Furthermore, a recording medium according to one aspect of the present disclosure is a non-transitory computer-readable recording medium having recorded thereon a program for causing a computer to execute the above-mentioned information processing method.

According to this aspect, the same advantageous effects as the above-mentioned information processing method are achieved.

It should be noted that these generic and specific aspects may be implemented as a system, a device, an integrated circuit, a computer program, or a computer-readable recording medium such as a CD-ROM, or may be implemented as any combination of a system, a device, an integrated circuit, a computer program, and a recording medium.

Hereinafter, an embodiment will be described in detail with reference to the drawings.

It should be noted that the embodiment described below merely illustrates a general or specific example of the present disclosure. The numerical values, shapes, materials, elements, the arrangement and connection of the elements, steps, the order of the steps, etc., described in the following embodiment are mere examples, and are therefore not intended to limit the present disclosure. Accordingly, among elements in the following embodiment, those not appearing in any of the independent claims defining the broadest concepts will be described as optional elements.

### Embodiment

This embodiment describes an information processing method and an information processing system that appropriately calculates fees according to a plurality of travel purposes of a moving body.

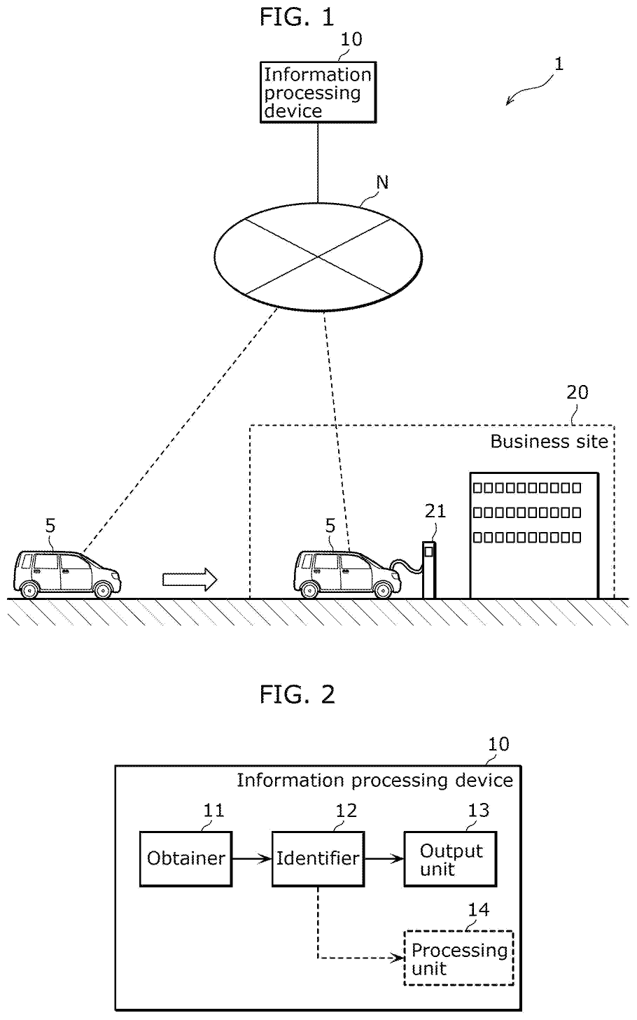

FIG. 1 is a schematic diagram illustrating a configuration and use of information processing system 1 according to the present embodiment.

As illustrated in FIG. 1, information processing system 1 is a system that manages an amount of charge of vehicle 5.

Vehicle 5 is an example of a moving body that is propelled by electrical power. Vehicle 5 includes a storage battery, and travels by being driven by a motor that uses electrical power discharged from the storage battery. The storage battery can be charged by charging facility 21. Vehicle 5 includes a communication interface, and is communicably connected to information processing device 10 via network N. It should be noted that vehicle 5 does not need to be constantly connected to network N, and only needs to be connected once every few hours or every few days. For example, vehicle 5 may connect to network N via a wired or wireless link when being charged by charging facility 21.

Vehicle 5 obtains its own location at intervals of a predetermined period of time (e.g., around a few seconds to a few minutes) by using positioning systems, such as the global positioning system (GPS), or the like. Furthermore, vehicle 5 obtains remaining battery levels of the storage battery (i.e., the state of charge (SoC)) at intervals of a predetermined period of time (e.g., around a few minutes). Vehicle 5 sends history information on locations obtained and remaining battery levels obtained to information processing device 10. It should be noted that history information may be sent immediately after a location or a remaining battery level is obtained, or history information collected over a given period of time (e.g., few hours to few days) may be sent all at once at intervals of the given period of time. When vehicle 5 is not constantly connected to network N, history information collected over time may be sent once a connection with network N is established.

Vehicle 5 may include electric automobiles, hybrid vehicles that are fueled by a combination of electrical power and other sources of energy (hereinafter refers to gasoline, or the like), electric two-wheeled vehicles, and the like. It should be noted that other examples of moving bodies propelled by electrical power may include marine vessels, aerial vehicles (drones), aircraft, and the like that are propelled by electrical power or a combination of electrical power and other sources of energy.

In addition to being used for travel for the purpose of performing work of a user, vehicle 5 is also used for travel for purposes other than performing work of the user. Here, travel for the purpose of performing work of the user is also referred to as “business travel” or a “first type of travel”, and travel for purposes other than performing work of the user is also referred to as “non-business travel” or a “second type of travel”.

Charging facility 21 is an example of a charging facility that charges vehicle 5, and is installed in business site 20 to which the user is assigned. Charging facility 21 is a charging facility predetermined to be a charging facility for charging vehicle 5 with electrical power to be used for the business travel of vehicle 5. It should be noted that charging facility 21 may be installed outside of business site 20. Furthermore, charging facility 21 is not limited to being owned by the owner or manager of business site 20, and may be owned by an entity that is affiliated with the owner or manager of business site 20.

Information processing device 10 is an information processing device that manages the amount of charge of vehicle Information processing device 10 may also execute a billing process for the amount of charge of vehicle 5. Hereinafter, information processing device 10 will be described in detail.

FIG. 2 is a block diagram illustrating a functional configuration of information processing device 10 according to this embodiment.

As illustrated in FIG. 2, information processing device 10 includes obtainer 11, identifier 12, output unit 13, and processing unit 14. The functional units included in information processing device 10 may be implemented by a processor (e.g., central processing unit (CPU)) (not illustrated in the figures), included in information processing device 10, executing a predetermined program using memory (not illustrated in the figures).

Obtainer 11 is a functional unit that obtains the information described below.

Obtainer 11 obtains the amount of charge when vehicle 5 is charged by charging facility 21.

Furthermore, obtainer 11 obtains history information on locations that vehicle 5 has traveled to and remaining battery levels during the travels of vehicle 5.

Additionally, obtainer 11 obtains waypoint information that indicates a location that vehicle 5 has passed through during business travel among the travels of vehicle 5. The waypoint information includes, for example, location information indicating a location of a visitation site visited during a business trip and location information of the home of the user who is an employee.

Identifier 12 is a functional unit that identifies the amount of power used for business travel and the amount of power used for non-business travel.

Identifier 12 identifies routes traveled by vehicle 5 by using the history information obtained by obtainer 11. Identifier 12 then identifies, by using the history information and the waypoint information obtained by obtainer 11, the amount of power used during business travel out of the amount of charge of vehicle 5 (business-related amount of power or first amount of power), or the amount of power used during non-business travel out of the amount of charge (non-business-related amount of power or second amount of power). It should be noted that identifier 12 may identify both the business-related amount of power and the non-business-related amount of power.

When identifying the business-related amount of power, identifier 12 may, for example, identify a portion of routes traveled by vehicle 5 during business travel (also referred to as a first route portion) out of the routes traveled by vehicle 5 by using the waypoint information. Then, identifier 12 identifies, out of the amount of charge, an amount of power used by vehicle to travel the first route portion, as the business-related amount of power. Identifier 12 determines, for example, whether the routes traveled by vehicle 5 include routes equivalent to round-trip travel between business site 20 and a visitation site visited during a business trip. When it is determined that the above-mentioned routes are included, the above-mentioned routes are identified as a “portion of the routes traveled by vehicle 5 during business travel”.

Furthermore, for example, when identifying the non-business-related amount of power, identifier 12 first identifies the first route portion traveled by vehicle 5 during business travel out of the routes traveled by vehicle 5 by using the waypoint information. Moreover, identifier 12 identifies a portion other than the first route portion (also referred to as a second route portion) from the routes traveled by vehicle 5. Then, identifier 12 identifies, out of the amount of charge, an amount of power used by vehicle 5 to travel the second route portion, as the non-business-related amount of power.

It should be noted that identifier 12 may further calculate the difference between the amount of carbon dioxide emissions generated if a vehicle fueled by gasoline were to travel the business travel and the amount of carbon dioxide emissions generated during the business travel of vehicle 5. Here, identifier 12 may calculate each of the above-mentioned amounts of carbon dioxide emissions and then calculate their difference, or identifier 12 may calculate the difference using published values of the amount of carbon dioxide emissions for vehicles fueled by gasoline and the amount of carbon dioxide emissions for electrified vehicles.

Output unit 13 is a functional unit that outputs the amount of power identified by identifier 12. Output unit 13 outputs the amount of power identified by identifier 12 by sending it via network N to a display device, or the like, different from information processing device 10. If identifier 12 calculates the difference in the amount of carbon dioxide emissions, output unit 13 may further output the difference calculated.

Processing unit 14 is a functional unit that executes a billing process. When identifier 12 identifies the second amount of power, processing unit 14 executes a billing process for the second amount of power. The billing process for the amount of power is a process for collecting payment of an amount of money equivalent in value to the amount of power from the user. The billing process includes, for example, processes for deducting an amount equivalent to the amount of power from a bank account balance of the user, and adding an amount equal to the above-mentioned amount deducted to a bank account balance of a supplier of the power used for charging. It should be noted that processing unit 14 is not a required element.

It should be noted that, in the billing process, processing unit 14 may execute a process of billing for a monetary amount obtained by multiplying the second amount of power by a unit price equivalent to the market unit price of electrical power (also simply called unit price).

Furthermore, in the billing process, processing unit 14 may execute a process of billing for an amount obtained by multiplying the second amount of power by a predetermined proportion of the market unit price. The predetermined proportion may, for example, be set between 50 percent and 90 percent of the market unit price. Accordingly, a business owner is able to provide an employee with a form of compensation (a company benefit so to speak).

Furthermore, in the billing process, processing unit 14 may prohibit a process of billing for the first amount of power. This can be said to be equivalent to processing unit 14 executing a process of billing for the first amount of power with the unit price being set to zero.

Hereinafter, the processes performed by information processing device 10 will be described in detail.

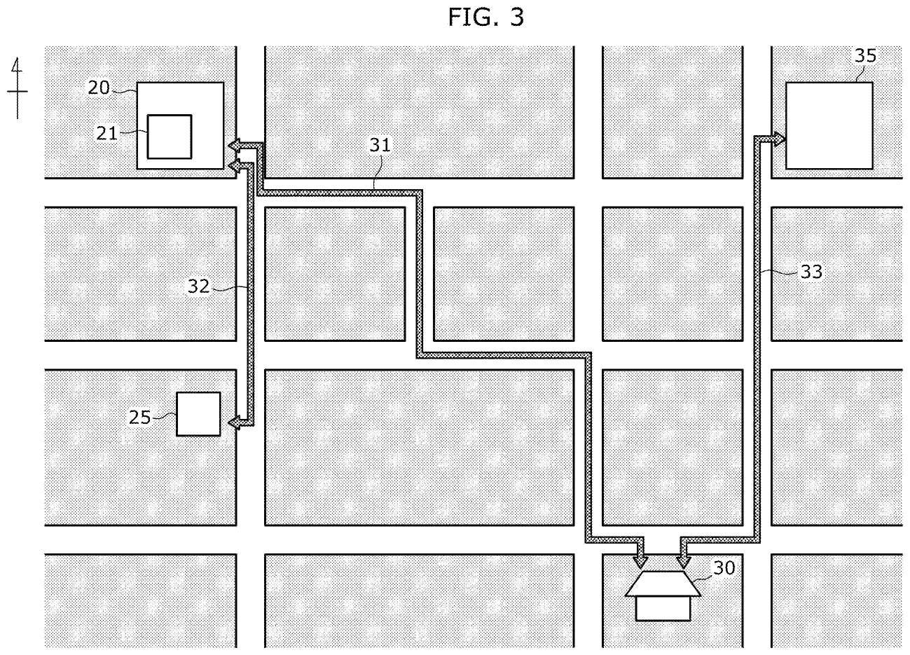

FIG. 3 is a schematic diagram illustrating an example of travel by vehicle 5 according to this embodiment.

As described above, vehicle 5 is used for both business travel and non-business travel of the user. As an example of travel by vehicle 5, FIG. 3 illustrates travel 31 for commuting, travel 32 for a business trip, and travel 33 for personal shopping.

Travel 31 for commuting is travel between home 30 of the user and business site 20, which is the workplace of the user, and is included in business travel.

Travel 32 for a business trip is travel between business site 20 and company C 25, which is a visitation site visited during a business trip of the user, and is included in business travel.

Travel 33 for personal shopping is travel between home 30 of the user and supermarket 35, which is a shopping location, and is included in non-business travel.

The routes of travel 31,32, and 33 illustrated in FIG. 3 are identified by identifier 12 from history information on the locations traveled by vehicle 5 obtained by obtainer 11.

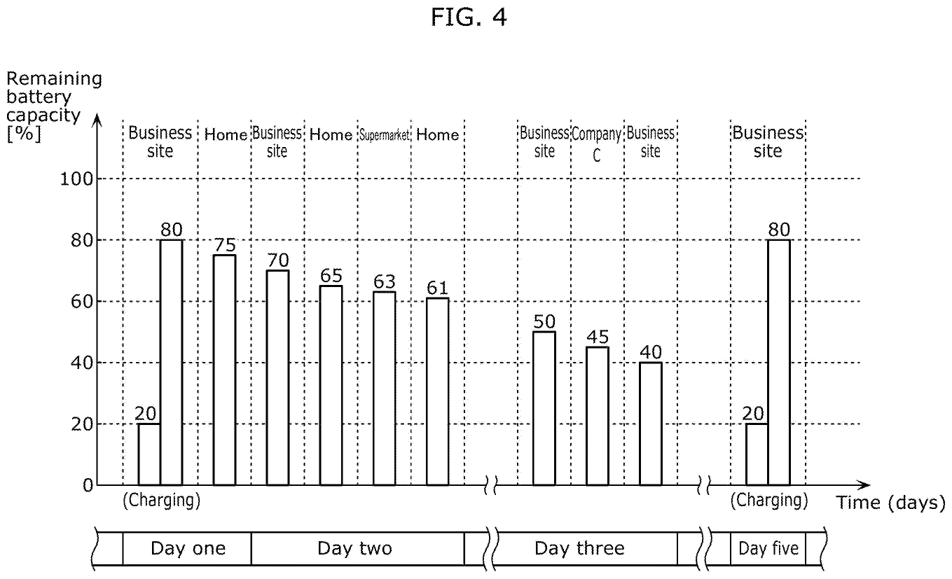

FIG. 4 is a schematic diagram illustrating an example of remaining battery levels of vehicle 5 according to this embodiment. The remaining battery levels illustrated in FIG. 4 illustrate fluctuations in remaining battery levels by both location of vehicle 5 and time when vehicle 5 travels as illustrated in FIG. 3.

On day one illustrated in FIG. 4, vehicle 5 is charged, thereby causing the remaining battery level to change from 20 percent to 80 percent. Here, it can be said that the remaining battery level is charged and replenished by 60 percent of the total battery capacity. Afterwards, vehicle 5 travels from business site 20 to home 30, thereby causing the remaining battery level to become 75 percent. On day two, vehicle 5 travels from home 30 to business site 20, thereby causing the remaining battery level to become percent. Afterwards, vehicle 5 sequentially travels to home supermarket 35, and home 30, thereby causing the remaining battery level to become 65 percent, 63 percent, and 61 percent, respectively.

Furthermore, on day three, vehicle 5 travels from business site 20 to company C 25, thereby causing the remaining battery level to become 45 percent, and then travels from company C 25 to business location 20, thereby causing the remaining battery level to become 40 percent.

Additionally, on day five, vehicle 5 is charged, thereby causing the remaining battery level to change from 20 percent to 80 percent.

The amount of charge that was charged on day one illustrated in FIG. 4 (i.e., amount of power equal to 60 percent of the total battery capacity) is obtained by vehicle 5 or charging facility 21 and sent to information processing device 10. Furthermore, history information on locations traveled to by vehicle 5 after being charged on day one and remaining battery levels during the travels is obtained by vehicle 5 and sent to information processing device 10. Information processing device 10 (i.e., obtainer 11) obtains the amount of charge and history information sent in the manner described above.

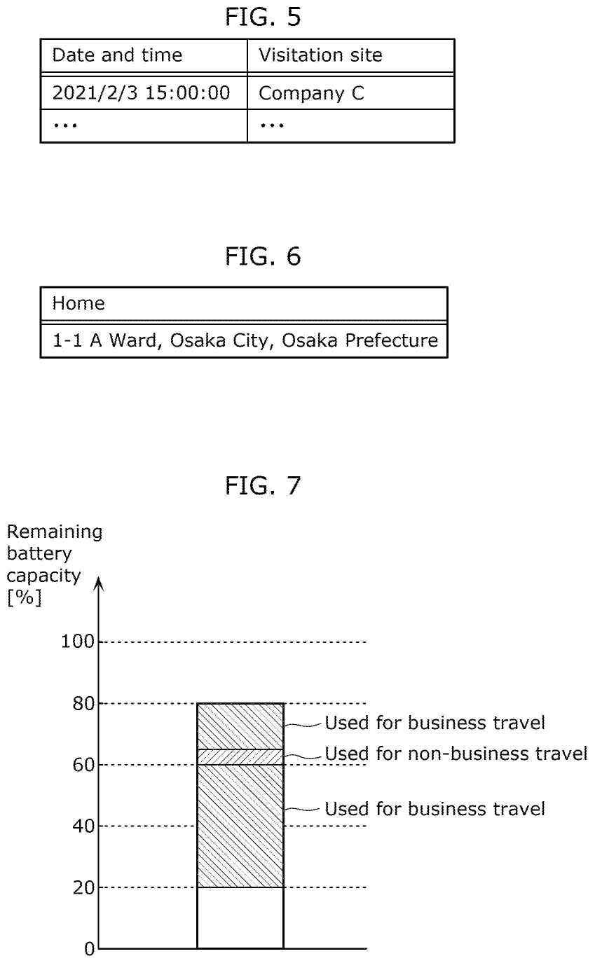

FIG. 5 is a diagram for describing a first example of waypoint information according to this embodiment. The first example of waypoint information illustrated in FIG. 5 is information on a business trip.

The information illustrated in FIG. 5 indicates the date and time of a business trip and a visitation site visited. Specifically, “Feb. 3, 2021 15:00” is illustrated as an example of a date and time of a business trip, and “Company C” is illustrated as an example of a visitation site.

The information illustrated in FIG. 5 may be a part of information on business trip instructions, a part of information on a travel expense report being submitted, or a part of work schedule information used for the work of the user.

By referring to the information illustrated in FIG. 5, identifier 12 can identify that, out of the routes traveled by vehicle 5, the travel of vehicle 5 between business site 20 and company C 25 during a predetermined period including “Feb. 3, 2021 15:00” is travel 32 for a business trip. Here, the beginning of the predetermined period may be set as a time obtained by subtracting, from the given time, the amount of time needed for one-way travel between business site 20 and company C 25. Furthermore, the end of the predetermined period may be set as a time obtained by adding, to the given time, the sum of the time spent at company C 25 and the amount of time needed for one-way travel between business site 20 and company C 25.

FIG. 6 is a diagram for describing a second example of waypoint information according to this embodiment. The second example of waypoint information illustrated in FIG. 6 is information on the home of the user.

The information illustrated in FIG. 6 is information that indicates the address of the home of the user. Specifically, “1-1 A Ward, Osaka City, Osaka Prefecture” is illustrated as an example of the address of the home of the user.

Note that it is sufficient that the information illustrated in FIG. 6 may be information that allows for the identification of the location of the home of the user at a predetermined accuracy (of a few meters to about ten meters, for example), and may be information that indicates the latitude and the longitude of the home of the user.

By referring to the information illustrated in FIG. 6, identifier 12 can identify that, out of the routes traveled by vehicle 5, the travel of vehicle 5 from home to business site 20 during a predetermined time of day for commuting to work (e.g., 7 a.m. to 10 a.m.) is travel 31 for commuting.

Furthermore, by referring to the information illustrated in FIG. 6, identifier 12 can identify that, out of the routes traveled by vehicle 5, the travel of vehicle 5 from business site 20 to home during a predetermined time of day for commuting from work (e.g., 5 p.m. to 9 p.m.) is travel 31 for commuting.

It should be noted that the predetermined times of day for commuting to work and commuting from work may be determined in advance based on the work schedule of the business site or the work schedule of each employee.

FIG. 7 is a diagram for describing a breakdown by purpose of the amount of charge identified by identifier 12 according to this embodiment. Specifically, the amount of charge illustrated in FIG. 7 indicates which of the portions of the amount of charge that was charged on day one in FIG. 4 were used for business travel or used for non-business travel.

As illustrated in FIG. 7, the 15 percent worth of the amount of charge from 80 percent to 65 percent of the remaining battery level was used for business travel. This corresponds to identifier 12 identifying that the travels of vehicle 5 from day one up to the travel on day two from business site 20 to home 30 in FIG. 4 is travel for commuting or, stated differently, business travel.

Furthermore, the 4 percent worth of the amount of charge from 65 percent to 61 percent of the remaining battery level was used for non-business travel. This corresponds to identifier 12 identifying that the round-trip travel between home 30 and supermarket 35 on day two in FIG. 4 is travel for personal shopping or, stated differently, non-business travel.

Moreover, the 41 percent worth of the amount of charge from 61 percent to 20 percent of the remaining battery level was used for business travel. This corresponds to identifier 12 identifying that the travels of vehicle 5 from after going shopping on day two to before being charged on day five in FIG. 4 is travel for commuting and travel for a business trip or, stated differently, business travel.

Here, it can be considered that the amount of charge charged on day one was used up over a period starting from after the charging on day one to before the charging on day five, and thus, a breakdown by purpose of the amount of charge that was charged on day one is being illustrated here. Conversely, it may also be considered that the power that was used up during the period starting from after the charging on day one to before the charging on day five was replenished through charging on day five. From this perspective, the amount of charge illustrated in FIG. 7 may be considered as showing a breakdown by purpose of the amount of charge that was charged on day five.

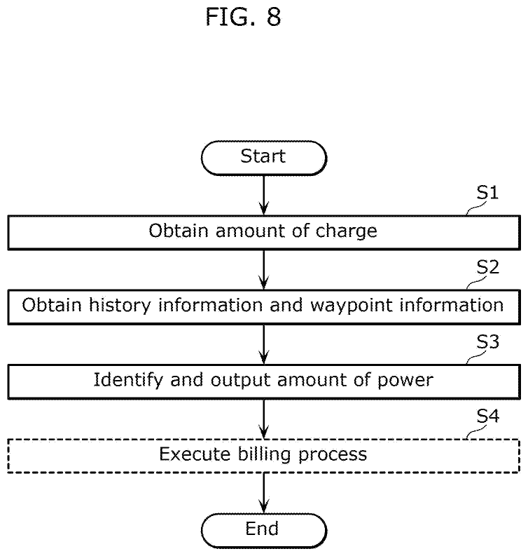

FIG. 8 is a flowchart illustrating an information processing method according to this embodiment.

As illustrated in FIG. 8, in step S1, obtainer 11 obtains the amount of charge when vehicle 5 is charged by charging facility 21.

In step S2, obtainer 11 obtains history information on locations that vehicle 5 has traveled to and remaining battery levels during the travels.

In step S3, identifier 12 identifies, by using the history information and the waypoint information obtained in step S2, the first amount of power used during the first type of travel out of the amount of charge obtained in step S1, or the second amount of power used during the second type of travel excluding the first type of travel, out of the aforementioned amount of charge. Output unit 13 outputs the first amount of power or the second amount of power identified by identifier 12.

In step S4, processing unit 14 executes the billing process for the second amount of power. It should be noted that step S4 is not essential.

With the series of processes illustrated in FIG. 8, it is possible to appropriately calculate fees according to a plurality of travel purposes of the moving body.

Although in this embodiment, a business trip is exemplified by round-trip travel between a business site and a visitation site, business trips may also include travel from home to a visitation site and travel from a visitation site to home. In such cases, for example, information indicating travel from home to a visitation site or travel from a visitation site to home may additionally be included in the waypoint information. Identifier 12 can identify, by referring to such waypoint information, that travel from home to a visitation site or travel from a visitation site to home is travel for a business trip. It should be noted that identifier 12 can also determine whether the time of visit to a visitation site is included in the commuting hours for commuting to work or commuting from work, and identify that the travel from home to the visitation site or travel from the visitation site to home is travel for a business trip when identifier 12 determines that the time of visit is included in the commuting hours. “Commuting hours” as described above may include, for example, a two to three hour period before or after the commuting hours of the user.

Although in this embodiment, a business trip is exemplified by round-trip travel between a business site and a visitation site, if the user were to travel for a purpose other than performing work in the middle of such travel, such travel may be excluded from business travel. For example, if the user were to stop by a convenience store located slightly off course from a predetermined route from a business site to a visitation site while on the way from the business site to the visitation site, travel to go off course from the predetermined route to the convenience store and travel to return from the convenience store to the predetermined route may be excluded from business travel and may be counted as non-business travel.

Although the present embodiment is described using an example of a configuration in which obtainer 11, identifier 12, output unit 13, and processing unit 14 are included in a single information processing device 10, a device that includes the above-mentioned functional units is not limited to this example. For example, by providing the above-mentioned functional units in a distributed manner across a plurality of information processing devices that can communicate with each other over network N, and exchanging information through communication via network N, the same processes as those of information processing device 10 according to the present embodiment can be executed. In this case, the plurality of information processing devices may be referred to as an information processing system. Furthermore, in this case, any one of the above-mentioned functional units of information processing device 10 may, for example, be included in vehicle 5 or may be included in charging facility 21.

Although the present embodiment is described using an example where travel for the purpose of performing work of the user is the first type of travel and where travel for purposes other than performing work of the user is the second type of travel, this example is non-limiting. For example, when the user is assigned two concurrent work duties, travel for the purpose of performing work for the first duty out of the two work duties may be the first type of travel and travel for the purpose of performing work for the second duty may be the second type of travel. Furthermore, when the user is assigned three or more concurrent work duties, one out of the three work duties may be designated as a first duty and the remaining work duties may be designated as second duties.

Furthermore, although in the foregoing embodiment, the respective elements are configured using dedicated hardware, the respective elements may be implemented by executing software programs suitable for the respective elements. The respective elements may be implemented by a program executer such as a CPU or a processor reading and executing a software program recorded on a recording medium such as a hard disk or a semiconductor memory. Herein, software that implements the information processing device, and the like, of the foregoing embodiment is a program such as the one described below.

The program is a program that causes a computer to execute an information processing method that includes: obtaining an amount of charge when a moving body propelled by electrical power is charged by a charging facility; obtaining history information on locations that the moving body has traveled to during travels and remaining battery levels during the travels; obtaining waypoint information that indicates a location that the moving body has passed through during a first type of travel among the travels; and identifying, by using the history information and the waypoint information, a first amount of power used during the first type of travel out of the amount of charge, or a second amount of power used during a second type of travel out of the amount of charge, and outputting the first amount of power or the second amount of power, the second type of travel being the travels excluding the first type of travel.

Although an information processing device, and the like, according to one or more aspects are described above based on the foregoing embodiment, the present disclosure is not limited to this embodiment. Forms obtained by various modifications to this or the foregoing embodiment that may be conceived by a person of ordinary skill in the art or forms obtained by combining elements in different embodiments, for as long as they do not depart from the essence of the present disclosure, may be included in the one or more aspects.

### INDUSTRIAL APPLICABILITY

The present disclosure is applicable to a device that manages the calculation of fees for electrical power.

1. An information processing method comprising:
obtaining an amount of charge when a moving body propelled by electrical power is charged by a charging facility;
obtaining history information on locations that the moving body has traveled to during travels and remaining battery levels during the travels;
obtaining waypoint information that indicates a location that the moving body has passed through during a first type of travel among the travels; and
identifying, by using the history information and the waypoint information, a first amount of power used during the first type of travel out of the amount of charge, or a second amount of power used during a second type of travel out of the amount of charge, and outputting the first amount of power or the second amount of power, the second type of travel being the travels excluding the first type of travel.

2. The information processing method according to claim 1, wherein
in the identifying of the first amount of power:
a first route portion is identified by using the waypoint information, the first route portion being a route traveled by the moving body during the first type of travel out of routes that the moving body has traveled during the travels; and
an amount of power, out of the amount of charge, used by the moving body to travel the first route portion is identified as the first amount of power.

3. The information processing method according to claim 1, wherein
in the identifying of the second amount of power:
a first route portion is identified by using the waypoint information, the first route portion being a route traveled by the moving body during the first type of travel out of routes that the moving body has traveled during the travels;
a second route portion is identified, the second route portion being the routes excluding the first route portion; and
an amount of power, out of the amount of charge, used by the moving body to travel the second route portion is identified as the second amount of power.

4. The information processing method according to claim 1, further comprising:
when the second amount of power is identified, executing a billing process for the second amount of power.

5. The information processing method according to claim 4, wherein
in the executing of the billing process, billing for an amount obtained by multiplying the second amount of power by a predetermined proportion of a market unit price of electrical power is executed.

6. The information processing method according to claim 4, wherein
in the executing of the billing process, billing for the first amount of power is prohibited.

7. The information processing method according to claim 1, further comprising:
calculating and outputting a difference between (a) an amount of carbon dioxide emissions generated in a case where a vehicle fueled by gasoline travels the first type of travel and (b) an amount of carbon dioxide emissions generated during the first type of travel of the moving body.

8. The information processing method according to claim 1, wherein
the charging facility is predetermined to be a charging facility for charging the moving body with electrical power to be used for the first type of travel of the moving body.

9. The information processing method according to claim 1, wherein
the first type of travel is for a purpose of performing work of a user, and
the second type of travel is for a purpose other than performing work of the user.

10. An information processing system comprising:
an obtainer that:
(a) obtains an amount of charge when a moving body propelled by electrical power is charged by a charging facility;
(b) obtains history information on locations that the moving body has traveled to during travels and remaining battery levels during the travels; and
(c) obtains waypoint information that indicates a location that the moving body has passed through during a first type of travel among the travels;
an identifier that identifies, by using the history information and the waypoint information, a first amount of power used during the first type of travel out of the amount of charge, or a second amount of power used during a second type of travel out of the amount of charge, the second type of travel being the travels excluding the first type of travel; and
an output unit that outputs the first amount of power or the second amount of power identified by the identifier.

11. A non-transitory computer-readable recording medium having recorded thereon a program for causing a computer to execute the information processing method according to claim 1.
